(19) United States
(12) Patent Application Publication
(10) Pub. No.: US 2008/0191030 A1
(43) Pub. Date: Aug. 14, 2008

(54) Single Side Package Memory Card

(75) Inventors: Abraham Chih-Kang Ma, Fremont, CA (US); Siew Sin Hiew, San Jose, CA (US); Jim Chin-Nan Ni, San Jose, CA (US)

Correspondence Address: LAW OFFICES OF IMAM, 111 N. MARKET STREET, SUITE 1010, SAN JOSE, CA, 95113, US

(73) Assignee: SUPER TALENT ELECTRONICS, INC., San Jose, CA (US)

(21) Appl. No.: 11/929,562

(22) Filed: Oct. 30, 2007

Related U.S. Application Data
(63) Continuation-in-part of application No. 10/913,868, filed on Aug. 6, 2004, now Pat. No. 7,264,992.
Application No. 10/913,868 is a continuation-in-part of application No. 11/773,830, filed on Jul. 5, 2007.
Application No. 11/773,830 is a continuation-in-part of application No. 11/309,847, filed on Oct. 12, 2006.
Application No. 11/309,847 is a continuation-in-part of application No. 11/624,667, filed on Jan. 18, 2007.
Application No. 11/624,667 is a division of application No. 09/478,720, filed on Jan. 6, 2000, now Pat. No. 7,257,714.

(51) Int. Cl. G06K 19/067

(52) U.S. Cl. 235/492

(57) ABSTRACT

In an embodiment of the present invention, a single-sided memory card includes a single-sided memory card includes an injection- or transfer-molded base including the cavity, a thermal adhesive glue sheet position in the cavity, a PCBA secured inside the cavity of the single-sided memory card through the thermal adhesive glue sheet, and an adhesive label position on top of the PCBA, causing the PCBA to be protected and, after heating, the adhesive is cured binding the injection- or transfer-molded base.

### CROSS REFERENCE TO RELATED APPLICATIONS

This application is a continuation-in-part of copending U.S. patent application Ser. No. 10/913,868 entitled “Removable Flash Integrated Memory Module Card and Method of Manufacture”, filed Aug. 6, 2004, and is a continuation-in-part of copending U.S. patent application Ser. No. 11/773,830, entitled “Molding Method to Manufacture Single-Chip Chip-On-Board USB Device”, filed on Jul. 5, 2007, and is a continuation-in-part of copending U.S. patent application Ser. No. 11/309,847 entitled “USB Device with Integrated USB Plug with USB-substrate Supporter Inside” and filed on Oct. 12, 2006 and is a continuation-in-part of U.S. patent application Ser. No. 11/624,667, entitled “Electronic Data Storage Medium with Fingerprint Verification Capability”, filed on Jan. 18, 2007 which is a divisional application of U.S. patent application Ser. No. 09/478,720, entitled “Electronic Data Storage Medium with Fingerprint Verification Capability” and filed on Jan. 6, 2000.

This application is related to U.S. Pat. No. 7,094,074, entitled “Manufacturing Methods for Ultra-Slim USB Flash-Memory Card with Supporting Dividers or Underside Ribs”, filed on Oct. 28, 2004.

### BACKGROUND OF THE INVENTION

1. Field of the Invention

The present invention relates generally to the field of removeably connectable memory cards (or devices) and particularly to card-based devices such as secure digital (SD) memory cards, mini-SD memory cards, and micro-SD memory cards.

2. Description of the Prior Art

As compact digital devices have gained enormous popularity in recent decades, so has the need for better and more efficient ways of storing memory. Notable among memory devices are the portable ones that may be carried around by the user to access information on different devices at different locations. This is particularly common in the case of personal computers (PC), digital cameras, and portable digital music players, where the need often arises to transfer data from one device to another. Examples of portable memory devices include nonvolatile memory devices such as an SD memory card that is removably connectible to a computer.

SD memory cards generally include a printed circuit board (PCB) or chip-on-board (COB) including memory or nonvolatile memory and/or other electronic devices. Packaging of the COB is particularly vital because of the popularity the COB has enjoyed largely due to allowing packing in a small PCB area. SD memory cards are used extensively in consumer devices and as consumer gadgets are requiring increasingly large amounts of memory there is a need to provide that memory quickly and cheaply.

The need therefore arises for a single-sided memory card.

### SUMMARY OF THE INVENTION

Briefly, an embodiment of the present invention includes a single-sided memory card includes an injection- or transfer-molded base including the cavity, a thermal adhesive glue sheet position in the cavity, a PCBA secured inside the cavity of the single-sided memory card through the thermal adhesive glue sheet, and an adhesive label position on top of the PCBA, causing the PCBA to be protected and, after heating, the adhesive is cured binding the injection- or transfer-molded base.

The foregoing and other objects, features and advantages of the present invention will be apparent from the following detailed description of the preferred embodiments which make reference to several figures of the drawing.

### IN THE DRAWINGS

FIG. 1 a top side, bottom side, and exploded view of a single-sided memory card 100 is shown in accordance with an embodiment of the present invention.

FIG. 2 shows further details of relevant components comprising the manufacture of the single-sided SD memory card.

FIG. 3 shows further details of the Printed Circuit Board Assembly 104.

FIG. 4 shows the PCBA 104 being taped into a readied plastic base 200.

FIG. 5 shows a plastic (or paper) label 103 being applied to an unlabeled memory card 400.

FIG. 6 shows a top side, bottom side, and exploded view of a single-sided memory card with write-protect switch 600 in accordance with another embodiment of the present invention.

FIG. 7 shows a top side, bottom side, and exploded view of a single-sided memory card with metal-case assembly 700 in accordance with another embodiment of the present invention.

FIG. 8 shows further details of relevant components a single-sided memory card with metal-case assembly 700, showing the metal-case completed metal base 800 construction.

FIG. 9 shows further details of a single-sided memory card with metal case 700, showing a thermal adhesive glue-sheet 105 being placed into a completed metal base 800 to form a tape-readied metal base 900.

FIG. 10 shows further details of a single-sided memory card with metal case 700, showing a PCBA 104 being placed into tape-readied metal base 900 to form an unlabeled memory card with metal case 1000.

FIG. 11 shows further details of a single-sided memory card with metal case 700, showing plastic (or paper) label 103 being placed on unlabeled memory card with metal case 1000 to form a single-sided memory card with metal case 700.

FIG. 12 shows a top side, bottom side, and exploded view of a single-sided memory card with over mold case assembly single-sided memory card with over-mold case 1200 in accordance with another embodiment of the present invention.

FIG. 13 shows further details of relevant components comprising single-sided memory card with over-mold case 1200.

FIG. 14 shows thermal adhesive glue sheet 105 being placed into over-mold base 1300 to form unlabeled single-sided memory card with over-mold case 1500.

FIG. 15 shows PCBA 104 being placed into readied over-mold base 1400 to form unlabeled single-sided memory card with over-mold case 1500.

FIG. 16 shows plastic (or paper) label 103 being placed onto unlabeled single-sided memory card with over-mold case 1500 to form single-sided memory card with over-mold case 1200.

### DETAILED DESCRIPTION OF THE EMBODIMENTS

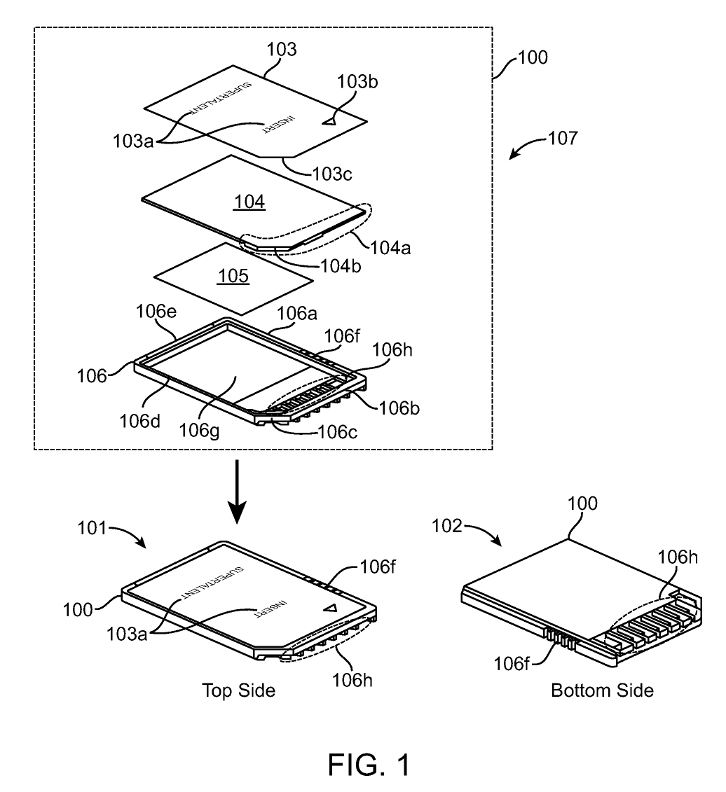

Referring now to FIG. 1, a top-view 101, bottom-view 102, and exploded-view 107 of a single-sided secure digital (SD) memory card 100 are shown in accordance with an embodiment of the present invention. The single-sided memory card 100 is shown to include an adhesive plastic (or paper) label 103, a printed circuit-board assembly (PCBA) 104, a thermal adhesive glue sheet 105, and an injection- or transfer-molded plastic case 106. The single-sided memory card 100 is generally shown to be rectangular in shape and in one embodiment of the present invention conforms to the standard dimensions for SD memory cards measuring 24 mm wide×32 mm long×2.1 mm thick. It should be noted, however, that in other embodiments and methods of building the memory cards, they may be made of varying dimensions and other such constructions.

The plastic (or paper) label 103 is generally shown to be rectangular in shape in accordance with the present invention and is shown to include markings 103a. These markings typically include text, graphics, pictures, or a combination thereof typically used to contain a company logo, association logo, version number, memory size, memory speed, or any other relevant or desired information. The plastic (or paper) label 103 also includes an insertion indicator 103b disposed near one corner of the label used to help the user of the single-sided memory card 100 to properly insert it into the host device. It should be noted, that this process is only an exemplary disposition and the indicator may be disposed anywhere on the label as long as the insertion indicator 103b indicates the proper insertion direction. In the embodiment of FIG. 1, the plastic (or paper) label 103 is also shown to have a tapered edge 103c to conform to the standards off the SD memory card.

The PCBA 104 is also shown to be generally rectangular in shape in accordance with an embodiment of the present invention. The PCBA 104 is shown to have at a bottom surface thereof, contact pins 104a. The host-contact pins are used to transfer information between the single-sided memory card 100 and the host device when the single-sided memory card 100 is coupled with the host device. In the embodiment of FIG. 1, the PCBA 104 is also shown to have a tapered edge 104b to conform to the standards off the SD memory card.

The thermal adhesive glue sheet 105 is shown to be generally rectangular in shape in accordance with an embodiment of the present invention. The thermal adhesive glue sheet 105 is smaller in size than the plastic (or paper) label 103, PCBA 104, and injection- or transfer-molded plastic case 106 so that it can fit into the cavity 106g.

The injection- or transfer-molded plastic case 106 is shown to be generally rectangular in shape in accordance with an embodiment of the present invention. It is comprised of a plurality of lateral sides including the lateral side 106a, leading lateral side 106b, tapered lateral side 106c, lateral side 106d and trailing lateral side 106e. The sides lateral side 106a, leading lateral side 106b, tapered lateral side 106c and lateral side 106d and trailing lateral side 106e form a cavity 106g that holds the plastic (or paper) label 103, PCBA 104, and thermal adhesive glue sheet 105. Lateral side 106a is shown to have slits 106f. The slits 106f are used to enhance user grip on the single-sided memory card 100 when, for example, the single-sided memory card 100 is being connected or removed from a host.

Leading edge 106b and tapered edge 106c are attached to a series of plastic ribs 106h. These plastic ribs are used to separate the contact pins 104a and to guide them into proper position when the single-sided memory card 100 is properly inserted into the host device. Tapered lateral side 106c facilitates proper insertion both by guiding the single-sided memory card 100 into a mating connector of a host when properly inserted but also by preventing full insertion into a host connector when it is improperly inserted.

During assembly of the single-sided memory card 100, the PCBA 104 is secured into the injection- or transfer-molded plastic case 106 via the thermal adhesive glue sheet 105. The adhesive label 103 is placed on top of the PCBA 104 to form a PCBA sub-assembly. The adhesive plastic (or paper) label 103 is then placed on top of the PCBA sub-assembly. After the adhesive plastic (or paper) label 103 is placed on top of the PCBA 104, the single-sided memory card 100 is heated for approximately 3-5 minutes at 160 degrees to cure the adhesive.

In an exemplary application, the single-sided memory card 100 is removably connectable to a host device, such as a PC, digital camera, or other electronic device, for storing information in the memory included on the PCBA 104. The single-sided memory card 100 is a compact device in large part due to surface mount technology (SMT) which requires no leads or wires for connecting electrical components.

The single-sided memory card 100 is superior to previous methods of manufacturing memory cards because it single-sided, meaning it utilizes only a single injection- or transfer-molded plastic case 106, instead of two. By requiring only a single injection- or transfer-molded plastic case 106 , the single-sided memory card 100 uses less material and utilizes fewer steps in construction. This, in turn, reduces cost and increases production speed.

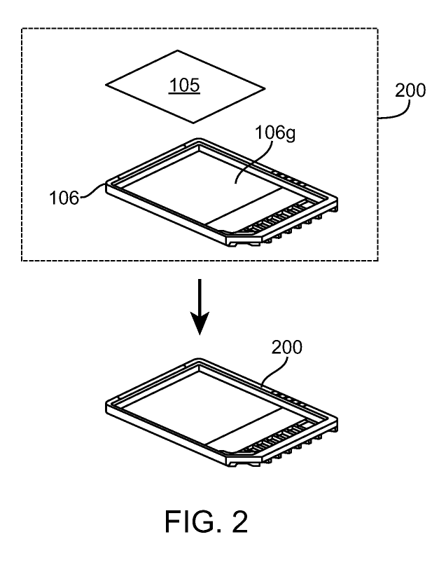

Referring now to FIG. 2, a readied plastic base 200 is shown to include the injection- or transfer-molded plastic base 106 and the thermal adhesive glue sheet 105 after the thermal adhesive glue sheet 105 has been inserted into the cavity 106g of the transfer- or injection-molded plastic case 106. During a step in the manufacturing process of the single-sided memory card 100, the thermal adhesive glue sheet 105 is placed into the cavity 106g of the injection- or transfer-molded plastic case 106 to form the readied plastic case 200.

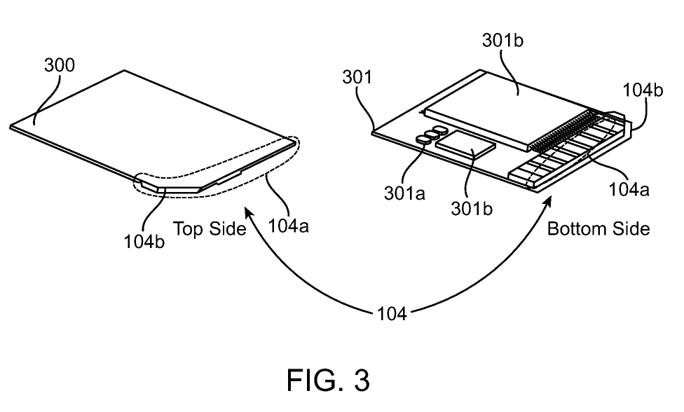

Referring now to FIG. 3, a top- 300 and bottom-side 301 of the PCBA 104 is shown in accordance with an embodiment of the present invention. The single-sided PCBA is shown to include a tapered corner 104b, contact pins 104a, passive electrical components such as capacitors and resistors 301a, controller chip 301b, and memory module 301c.

Referring now to FIG. 4, an unlabelled memory card 400 is shown to include the PCBA 104 and readied plastic base 200 after the PCBA 104 has been inserted into the readied plastic base 200. During a step in the manufacturing process, the PCBA is inserted into the readied plastic base to form the unlabelled memory card 400.

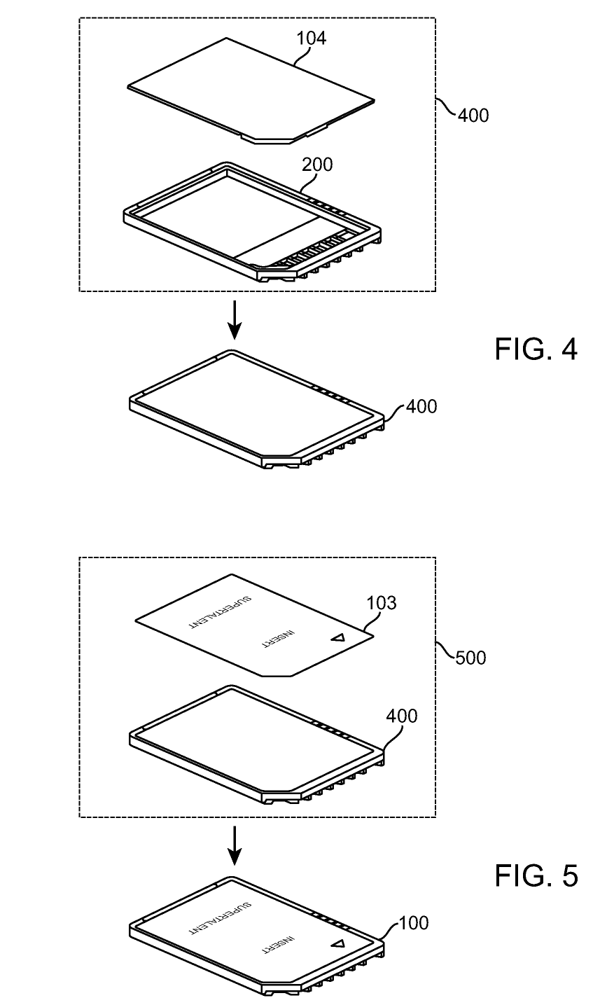

Referring now to FIG. 5, a single-sided memory card 100 is shown to include the unlabelled memory card 400 and the plastic (or paper) label 103 after the plastic (or paper) label 103 is applied to the unlabeled memory card. During a step in the manufacturing process the plastic (or paper) label 103 is applied to the unlabeled memory card to form the single-sided memory card 100.

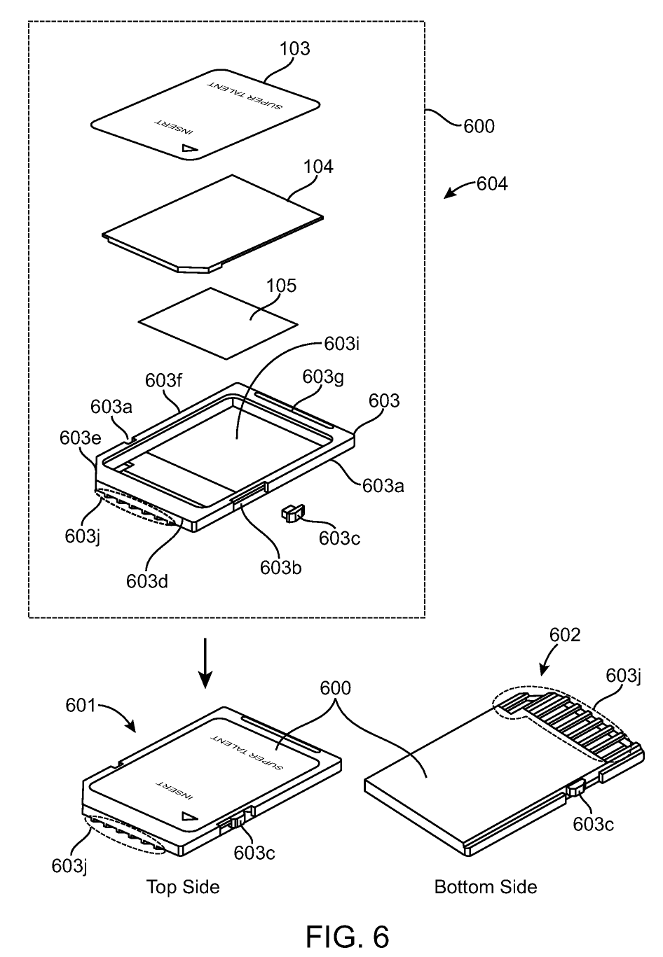

Referring now to FIG. 6, a top-side 601, bottom-side 602, and exploded view 604 of a single-side memory card with write-protect switch 600 are shown in accordance with the present invention. The single-side memory card with write-protect switch 600 is shown to include plastic (or paper) label 103, PCBA 104, thermal adhesive glue sheet 105, and injection- or transfer molded base with write-protect slot injection- or transfer molded base with write-protect slot 603. The single-side memory card with write-protect switch 600 is generally shown to be rectangular in shape and in one embodiment of the present invention conforms to the standard dimensions for SD memory cards measuring 24 mm wide×32 mm long×2.1 mm thick. It should be noted, however, that in other embodiments of building the memory cards, they may be made of varying dimensions and other such constructions.

The plastic (or paper) label 103, PCBA 104, and thermal adhesive glue sheet 105 are identical and are described, supra pages 1-2. Further discussion here is avoided to reduce redundancy.

The injection- or transfer molded base with write-protect slot 603 is shown to be generally rectangular in shape in accordance with an embodiment of the present invention. It is comprised of a plurality of sides including the lateral side 603a, leading lateral edge leading lateral side 603d, tapered lateral edge tapered lateral side 603e, lateral side lateral side 603f, and trailing lateral side trailing lateral side 603g. Lateral side 603a, leading lateral side 603d, tapered lateral side 603e, lateral side 603f and trailing lateral side 603g form cavity 603i that holds plastic (or paper) label 103, PCBA 104, and thermal adhesive glue sheet 105. Lateral side 603a is shown to have write-protect slot 603b into which write-protect switch 603c is inserted. Write-protect switch 603c allows the end-user to switch the card between read/write and read-only modes. Lateral side 603f has notch 603h that is part of the write-protect system.

Leading lateral side 603d and tapered lateral side 603e are attached to plastic rib-structure 603j. Plastic rib-structure 603j is used to separate contact pins 104a and to guide them into proper position when single-side memory card with write-protect switch 600 is properly inserted into the host device. Tapered lateral side 603e facilitates proper insertion both by guiding the single-side memory card with write-protect switch 600 into a mating connector of a host when properly inserted but also by preventing full insertion into a host computer when it is improperly inserted.

During assembly of single-side memory card with write-protect switch 600, PCBA 104 is secured into injection- or transfer molded base with write-protect slot 603 via thermal adhesive glue sheet 105. plastic (or paper) label 103 is placed on top of PCBA 104 and single-side memory card with write-protect switch 600 is then heated for approximately 3-5 minutes at 160 degrees Celsius to cure the adhesive.

In an exemplary application single-side memory card with write-protect switch 600 is removably connectable to a host device such as a PC, digital camera, or other electronic device for storing information in the memory included on PCBA 104. Injection- or transfer molded base with write-protect slot 603 gives the user the option to set the invention in read/write or write-protect modes. single-side memory card with write-protect switch 600 is a compact device in large part due to SMT which requires no leads or wires for connecting electrical components.

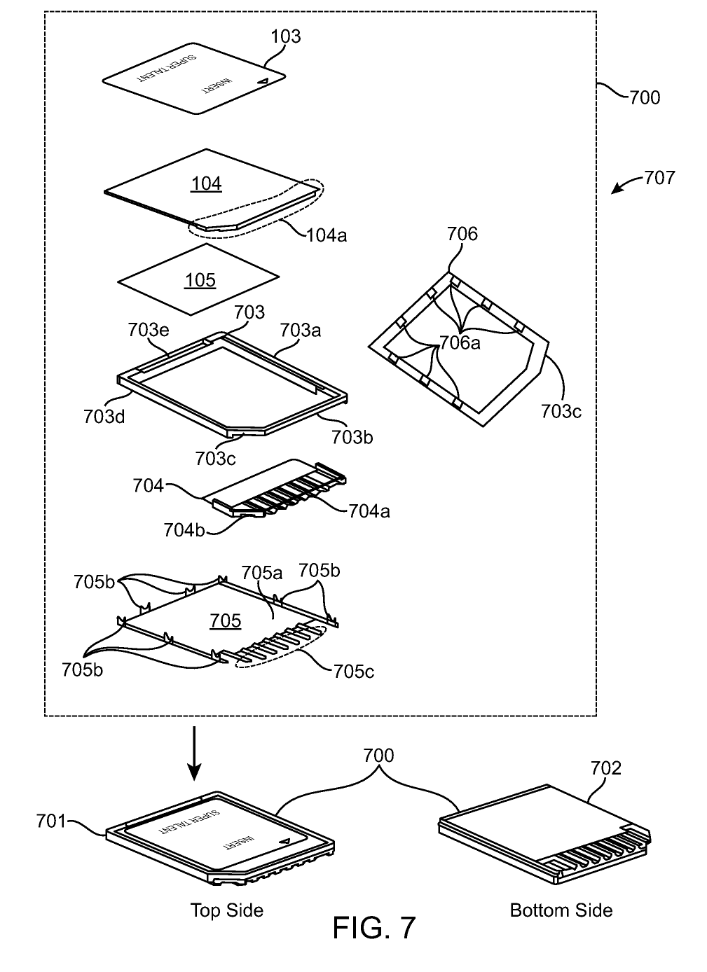

Referring no to FIG. 7, a top-view 701, bottom-view 702, and exploded-view 707 of single-sided memory card with metal case 700 are shown in accordance with an embodiment of the present invention. Single-sided memory card with metal case 700 is shown to include plastic (or paper) label 103, PCBA 104, thermal adhesive glue sheet 105, metal frame 703, plastic rib-structure 704, and metal base 705. Single-sided memory card with metal case 700 is shown to be generally rectangular in shape and in one embodiment of the present invention conforms to the standard dimensions for SD memory cards measuring 24 mm wide×32 mm long by 2.1 mm thick. It should be noted, however, that in other embodiments and methods of build the memory cards, they may be made of varying dimensions and other such constructions.

Plastic (or paper) label 103, PCBA 104, and thermal adhesive glue sheet 105 are identical and are described, supra pages 1-2. Further discussion here is avoided to reduce redundancy.

Metal frame 703 is shown to be generally rectangular in shape in accordance with an embodiment or the present invention. Metal frame 703 is comprised of lateral side 703a, leading lateral edge 703b tapered lateral edge 703c, lateral edge 703c, and lateral edge lateral edge 703e. The underside of metal frame 703, indicated as bottom view of the metal frame 706, has slots for metal hooks 706a.

Plastic rib-structure 704 is shown to be generally rectangular in shape in accordance with an embodiment of the present invention. It measures a similar width to metal frame 703 and metal base 705, but is shorter in order to fit between metal frame 703 and metal base 705. It is comprised of plastic ribs 704a and tapered edge 704b. Plastic ribs 704a are used to separate the contact pins 104a and to guide them into proper position when single-sided memory card with metal case 700 is properly inserted into the host device.

Metal base 705 is shown to be rectangular in shape in accordance with an embodiment of the present invention. It is comprised of metal floor 705a, metal hooks 705b and metal ribs 705c. Metal floor 705a provides a platform for the placement of plastic (or paper) label 103, PCBA 104, and thermal adhesive glue sheet 105.

During assembly of single-sided memory card with metal case 700, metal frame 703 is placed above plastic rib-structure 704. Plastic rib-structure 704 is in turn placed above metal base 705. Metal hooks 705b on metal base 705 hook into the slots for metal hooks 706a on bottom view of the metal frame 706, holding plastic rib-structure 704 in-between them.

In an exemplary application, single-sided memory card with metal case 700 is removably connectable to a host device, such as a PC, digital camera, or other electronic device, for storing information in the memory included on PCBA 104. Single-sided memory card with over-mold case 1200 is a compact device in large part due to the SMT which requires no leads or wires for connecting electrical components.

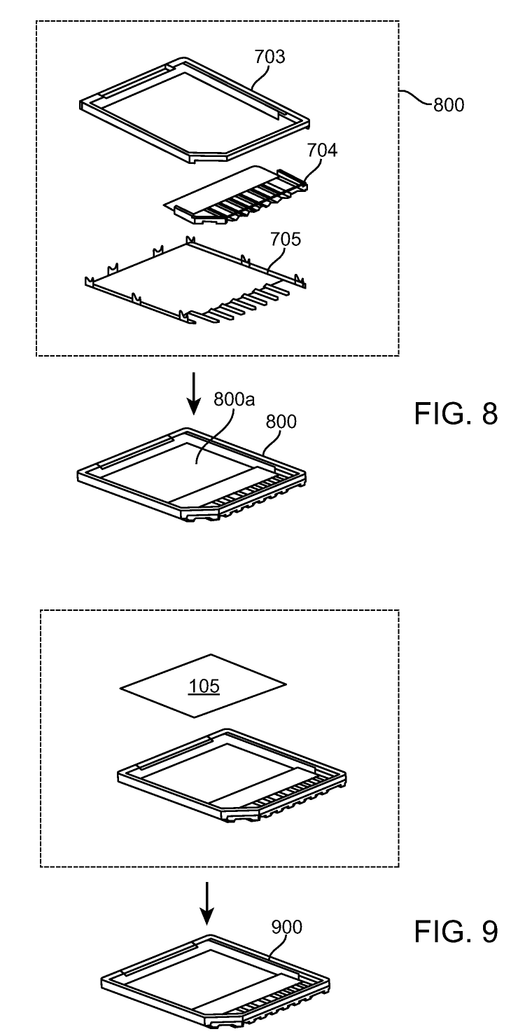

Referring now to FIG. 8, completed metal base 800 is shown to include metal frame 703, plastic rib-structure 704, and metal base 705. During a step of the manufacturing process, plastic rib-structure 704 is placed in-between metal frame 703 and metal base 705. Metal frame 703 and metal base 705 are then snapped together to form completed metal base 800, inclusive of cavity 800a.

Referring now to FIG. 9, a tape-readied metal base 900 is shown to be comprised of metal base 800 and thermal adhesive glue sheet 105 after thermal adhesive glue sheet 105 has been inserted into cavity 800a of completed metal base 800. During a step in the manufacturing process of single-sided memory card with metal case 700, thermal adhesive glue sheet 105 is placed into cavity 800a of completed metal base 800 to form a tape-readied metal base 900.

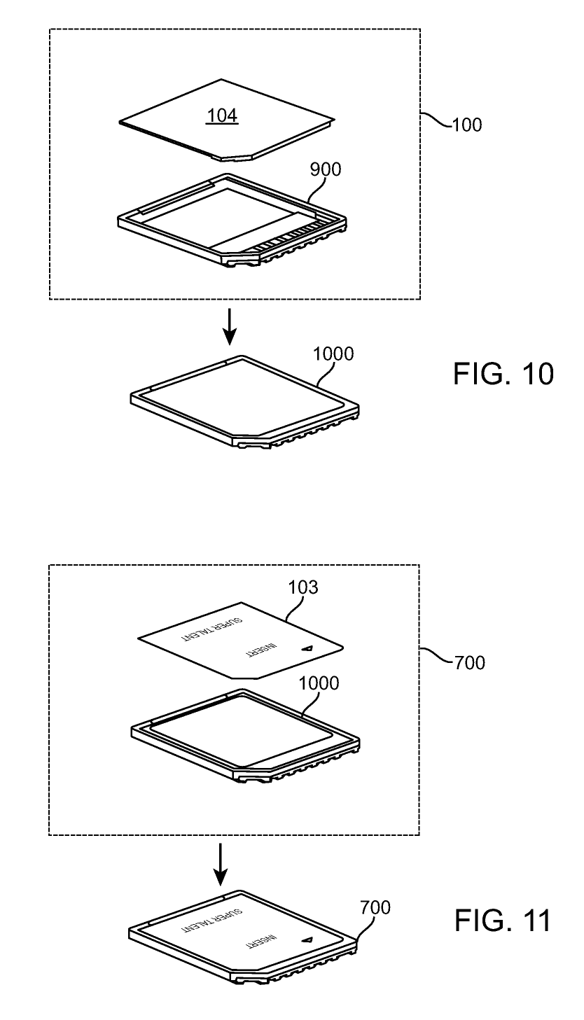

Referring now to FIG. 10, unlabeled memory card with metal case 1000 is shown to include PCBA 104 and a tape-readied metal base 900 after PCBA 104 has been placed into a tape-readied metal base 900. During a step in the manufacturing process, PCBA 104 is placed into a tape-readied metal base 900 to form unlabeled memory card with metal case 1000.

Referring now to FIG. 11, single-sided memory card with metal case 700 is shown to include plastic (or paper) label 103 and unlabeled memory card with metal case 1000 after plastic (or paper) label 103 is placed on top of unlabeled memory card with metal case 1000. During a step in the manufacturing process, plastic (or paper) label 103 is placed on top of unlabeled memory card with metal case 1000. After plastic (or paper) label 103 is placed on top of unlabeled memory card with metal case 1000 to form single-sided memory card with metal case 700, single-sided memory card with metal case 700 is heated for 3-5 minutes at 160 degrees Celsius to sure the adhesive.

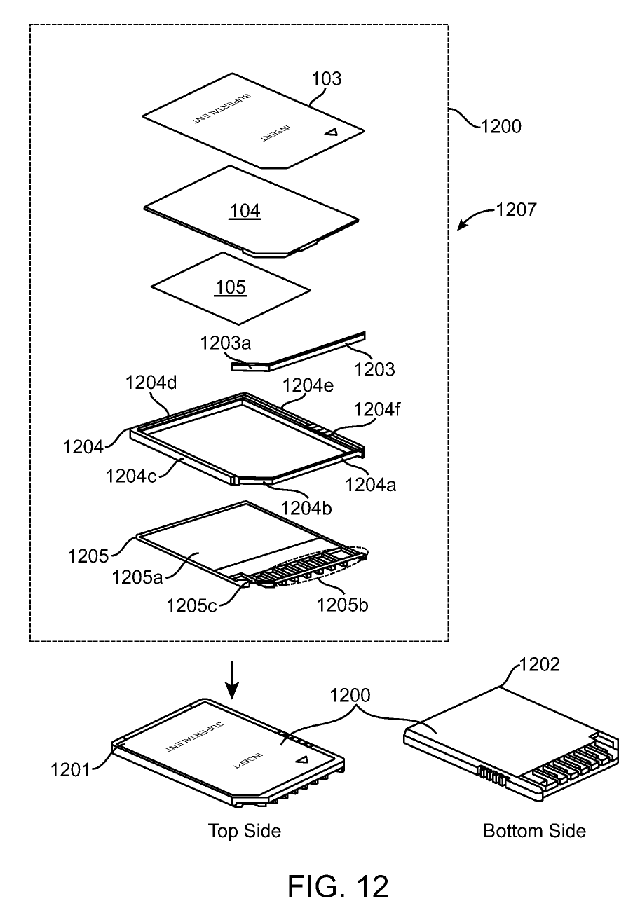

Referring now to FIG. 12, a top-side 1201, bottom-side 1202, and exploded 1207 view of single-sided memory card with over-mold case 1200 are shown in accordance with an embodiment of the present invention. Single-sided memory card with over-mold case 1200 is shown to include plastic (or paper) label 103, PCBA 104, thermal adhesive glue sheet 105, plastic frame-guard bar 1203, metal frame 1204, and plastic base 1205. Single-sided memory card with over-mold case 1200 is generally shown to be rectangular in shape and in one embodiment of the present invention conforms to the standard dimensions for SD memory cards measuring 24 mm wide by 32 mm long×2.1 mm thick. It should be noted, however, that in other embodiments and methods of building the memory cards they may be made of varying dimensions and other such constructions.

Plastic (or paper) label 103, PCBA 104, and thermal adhesive glue sheet 105 are identical and is described, supra pages 1-2. Further discussion here is avoided to reduce redundancy.

Plastic frame-guard bar 1203 has a tapered corner tapered corner 1203a. Plastic frame-guard bar 1203 is used to slightly lift metal frame 1204 to prevent a short-circuit.

Metal frame 1204 is shown to include leading lateral edge 1204a, tapered lateral edge 1204b, lateral edge 1204c, trailing lateral edge 1204d, and lateral edge 1204e in accordance with an embodiment of the present invention. Lateral edge 1204e is shown to have slits 1204f. Slits 1204f is used to enhance user grip on single-sided memory card with over-mold case 1200 when, for example, single-sided memory card with over-mold case 1200 is being connected to or removed from a host device.

Plastic base 1205 is shown to include plastic base floor 1205a, plastic base tapered edge 1205b, and plastic base plastic rib-structure 1205c. plastic base tapered edge 1205b are used to separate the contact pins 104a and to guide them into proper position when single-sided memory card with over-mold case 1200 is properly inserted into a host device. Plastic base plastic rib-structure 1205c facilitates proper insertion both by guiding single-sided memory card with over-mold case 1200 into a mating connector of a host device.

During assembly of single-sided memory card with over-mold case 1200, PCBA 104 is secured into the case via thermal adhesive glue sheet 105. The adhesive label is placed on top of PCBA 104. After plastic (or paper) label 103 has been placed on top of PCBA 104, single-sided memory card with over-mold case 1200 is heated for 3-5 minutes at approximately 160 degrees to cure the adhesive.

In an exemplary application, single-sided memory card with over-mold case 1200 is removably connectable to a host device, such as a PC, digital camera, or other electronic device, for storing information in the memory included on the PCBA 104. Single-sided memory card with over-mold case 1200 is a compact device in larger part due to the SMT which requires no leads or wires for connecting electrical components.

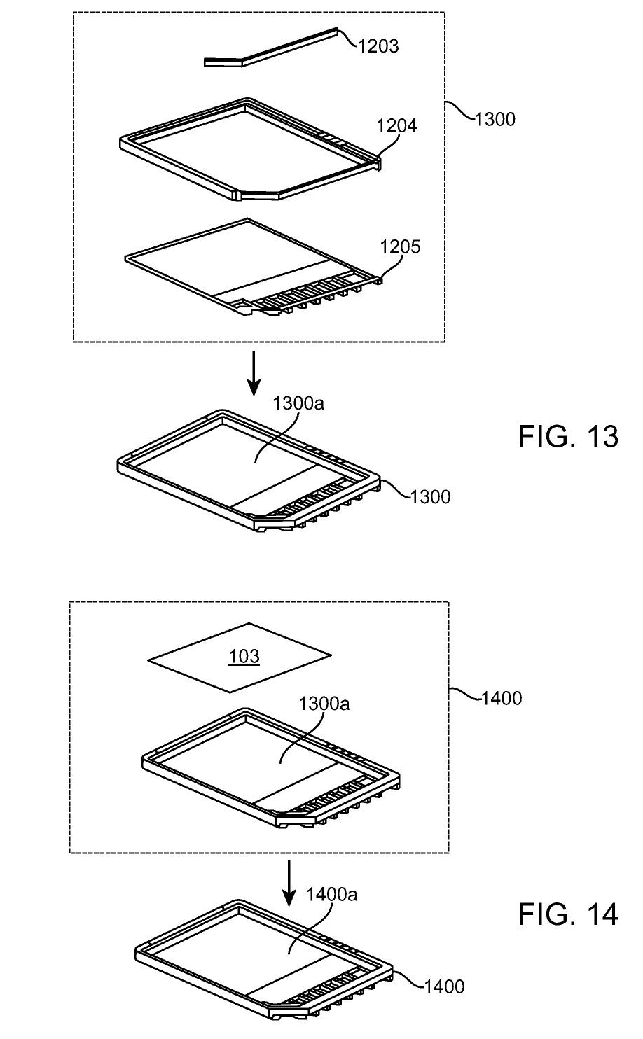

Referring now to FIG. 13, over-mold base 1300 is shown to include plastic frame-guard bar 1203, metal frame 1204, and plastic base 1205 in accordance with an embodiment of the present invention. During a step in the manufacturing process plastic frame-guard bar 1203, metal frame 1204, and plastic base 1205 are pressed together to form over-mold base 1300.

Referring now to FIG. 14, readied over-mold base 1400 is shown to include plastic (or paper) label 103 and over-mold base 1300 in accordance with an embodiment of the present invention. During a step in the manufacturing process plastic (or paper) label 103 is placed onto over-mold base cavity 1300a to form readied over-mold base 1400.

Referring now to FIG. 15, unlabeled single-sided memory card with over-mold case 1500 is shown to include PCBA 104 and readied over-mold base 1400 in accordance with an embodiment of the present invention. During a step in the manufacturing process PCBA 104 is placed into readied over-mold base 1400a to form unlabeled single-sided memory card with over-mold case 1500.

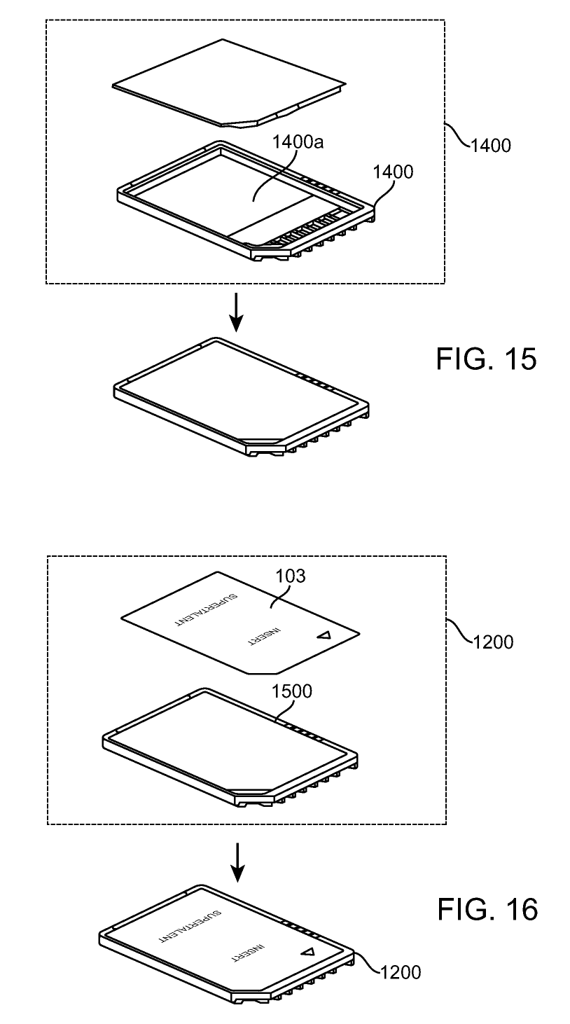

Referring now to FIG. 16, single-sided memory card with over-mold case 1200 is shown to include plastic (or paper) label 103 and unlabeled single-sided memory card with over-mold case 1500 in accordance with an embodiment of the present invention. During a step of the manufacturing process, plastic (or paper) label 103 is placed on unlabeled single-sided memory card with over-mold case 1500 to form single-sided memory card with over-mold case 1200.

What is claimed is:

1. A single-sided memory card comprising:
an injection- or transfer-molded base including the cavity;
a thermal adhesive glue sheet position in the cavity;
a PCBA secured inside the cavity of the single-sided memory card through the thermal adhesive glue sheet; and
an adhesive label position on top of the PCBA, causing the PCBA to be protected and, after heating, the adhesive is cured binding the injection- or transfer-molded base.

2. A single-sided memory card, as recited in claim 1, wherein the PCBA has disposed on a surface thereof capacitors, resistors, a controller chip, memory chip, and contact pin.

3. A single-sided memory card, as recited in claim 2, wherein the injection- or transfer molded case is made up of a plurality of sides and a base that form a rectangular cavity and where one of the lateral sides has slits disposed thereupon.

4. A single-sided memory card, as recited in claim 3, wherein the components are joined with heat-activated glue.

5. A single-sided memory card, as recited in claim 4, further including a label disposed on top of said PCBA to protect the PCBA.

6. A single-sided memory card, as recited in claim 5, wherein the memory card is coupled to a host device to transfer information between said memory card and said host device.

7. A single-sided memory card, as recited in claim 5, to further include an interface adapted to couple the memory card to the host device.

8. a single-sided memory card with write-protect switch comprising:
An injection- or transfer-molded base including the cavity and lateral side with a slot for the write-protect switch;
a thermal adhesive glue sheet position in the cavity;
a PCBA secured to the single-sided memory card through the thermal adhesive glue sheet;

9. A memory card, as recited in claim 8, wherein a slot is formed on one of the plurality of lateral sides of the sub-assembly.,

10. A memory card, as recited in claim 9, wherein a dynamic switch device is in the notch of one of the plurality of lateral sides of the sub-assembly, which, depending on its selectable position, causes the card to operate in either read-write, or write-protect mode.

11. A memory card, as recited in claim 9, wherein a read-write plug is insertably positioned into the notch on one of the plurality of lateral sides, where the memory card is configured to function in a read-write mode when the read-write plug is positioned into the notch, and in a write-protect mode when the notch is exposed. A single-sided memory card, as recited in claim 1, wherein the PCBA has disposed on a surface thereof capacitors, resistors, a controller chip, memory chip, and contact pin.

12. A single-sided memory card, as recited in claim 9, wherein the injection- or transfer molded case is made up of a plurality of sides and a base that form a rectangular cavity and where one of the lateral sides has slits disposed thereupon.

13. A single-sided memory card, as recited in claim 12, wherein the components are joined with heat-activated glue.

14. A single-sided memory card, as recited in claim 14, further including a label disposed on top of said PCBA to protect the PCBA.

15. A single-sided memory card, as recited in claim 14, wherein the memory card is coupled to a host device to transfer information between said memory card and said host device.

16. A single-sided memory card, as recited in claim 15, to further include an interface adapted to couple the memory card to the host device.

17. A single-sided memory card with metal case assembly comprising:
a metal base with metal hooks;
a plastic rib piece;
a metal frame with corresponding slots into which the metal hooks on the metal base snap to form the metal case assembly;
a thermal adhesive glue sheet position in the cavity;
a PCBA secured to the single-sided memory card through the thermal adhesive glue sheet; and
an adhesive label position on top of the PCBA, causing the PCBA to be protected and, after heating, the adhesive is cured binding the injection- or transfer-molded base.

18. A single-sided memory card with over-mold metal frame comprising:
a plastic base
a plastic frame-guard bar
a metal over mold frame;
a thermal adhesive glue sheet position in the cavity;
a PCBA secured to the single-sided memory card through the thermal adhesive glue sheet; and
an adhesive label position on top of the PCBA, causing the PCBA to be protected and, after heating, the adhesive is cured binding the injection- or transfer-molded base.
